(19) United States
(12) Patent Application Publication
(10) Pub. No.: US 2001/0021754 A1
(43) Pub. Date: Sep. 13, 2001

(54) Injection molding resin

(75) Inventors: Mark Weber, Calgary (CA); Christopher John Brooke Dobbin, Calgary (CA)

Correspondence Address: Kenneth H. Johnson, Patent Attorney, P.O. Box 630708, Houston, TX, 77263, US

(73) Assignee: NOVA Chemicals (International) S.A.

(21) Appl. No.: 09/773,945

(22) Filed: Feb. 1, 2001

(30) Foreign Application Priority Data
Feb. 10, 2000 (CA) 2298423

(51) Int. Cl. C08F 4/40

(52) U.S. Cl. 526/65; 526/73; 526/90; 525/53; 526/348.5; 526/348.2; 526/348.6

(57) ABSTRACT

Injection molded plastic parts (such as containers for ice cream or margarine, lids for the containers and crates) are made from a polyethylene resin having a controlled but narrow molecular weight distribution and a uniform comonomer distribution. The combination of narrow molecular weight distribution and uniform comonomer distribution allows the parts to be more easily molded whilst still maintaining a surprisingly high level of physical properties in the finished parts. The polyethylene resin is prepared in a dual reactor polymerization process.

### FIELD OF THE INVENTION

This invention relates to injection molded parts which are prepared from a narrow molecular weight distribution polyethylene resin. The resin is manufactured in a dual reactor polymerization process.

### BACKGROUND OF THE INVENTION

“Injection molding” is a well known fabrication process which is used to prepare a variety of plastic parts such as lids, containers, pallets, toys, crates and pails. Parts which are manufactured by injection molding vary in size from small to very large. This process typically encompasses an initial step in which the resin is heated and melted while being mixed and homogenized. The molten resin material is then injected into a closed mold cavity, where it takes the shape of the mold. In the mold cavity, the resin is cooled and solidified, and then the finished part is ejected. Polyolefin resins such as polyethylene and polypropylene are widely used to manufacture injection molded plastic parts. Polyolefin resins used for injection molding are generally characterized by having a high melt index and a narrow molecular weight distribution. Both of these resin characteristics are associated with good “processability” (i.e. ease of molding).

Commercially available polyolefin resins are prepared by many processes, including those known as “gas phase”, “slurry” and “solution”. A dual reactor solution polymerization process is described in commonly assigned Canadian Patent Application (CA) 2,201,224.

“Single reactor” polymerization processes are known for the preparation of injection molding resins because this is the easiest way to produce the narrow molecular weight distribution which is desirable for such resins.

“Dual reactor” polymerization processes are typically used for preparing polymers having broad molecular weight distributions. However, the polyethylene resin used in the present invention is prepared in a dual reactor polymerization process but has a comparatively narrow molecular weight distribution.

### SUMMARY OF THE INVENTION

The present invention provides an injection molded part made from polyethylene copolymer characterized in that said polyethylene copolymer is polymerized in a polymerization process having at least two stirred polymerization reactors arranged in series and operating at different polymerization temperatures.

As used herein, the term catalytic copolymerization means that the copolymerization is catalyzed by an organometallic-containing catalyst system (i.e. the term excludes polymerizations which are initialized by free radical generators such as peroxides). Preferred organometallic catalysts are described below in the Detailed Description.

### DETAILED DESCRIPTION

Injection molding equipment is widely available, is known to those skilled in the art and is well described in the literature. The equipment is highly productive, with molding cycle times often being measured in seconds. The equipment is also very expensive so there is a need to maximize productivity (i.e. minimize cycle times) in order to control overall production costs. Productivity may be influenced by the choice of resin used in the process. In particular, a resin which flows well is desirable to reduce cycle times. Flow properties are typically influenced by molecular weight (with low molecular weight resin having superior flow properties in comparison to high molecular weight resin) and molecular weight distribution (with narrow molecular weight resins generally having superior flow properties in comparison to broad molecular weight distribution resins). Moreover, the composition of the resin also influences flow properties. In particular, a homopolymer polyethylene generally has a better flow rate in comparison to a copolymer of similar molecular weight and molecular weight distribution.

Thus, the use of homopolymer polyethylene having a low molecular weight and a narrow molecular weight distribution generally provides superior flow properties. However, the strength of the finished product is also important. The strength of a finished product may often be increased by increasing the molecular weight of the resin used to prepare it. In addition, the use of a copolymer resin will often improve the impact strength and flexibility of a product in comparison to the use of homopolymer. Accordingly, a “strong” resin may reduce processability so there is a need to carefully balance “strength” and “processability” characteristics.

We have now discovered that excellent polyethylene injection molding resins may be prepared in a dual reactor polymerization process. The polyethylene resins of this invention are “copolymers” (i.e. the resins contain a small amount of comonomer, as discussed in part B of the Detailed Description). The resins are further characterized by having a narrow molecular weight distribution (preferably less than 5, if made with a Ziegler Natta catalyst and preferably less than 3, if made with a single site catalyst). The preferred molecular weight is a function of the part which is produced. Melt index, (“I₁₂”), is used by those skilled in the art as a proxy for molecular weight. I₂ is determined by ASTM standard D1238, condition 190° C./2.16 kg. Small containers according to this invention (having a nominal volume of less than 4 liters, such as containers for margarine, ice cream, sour cream or deli products) have a melt index of from 20 to 50 grams per 10 minutes, especially from 50 to 100 g/l0 minutes. Preferred densities for the copolymers used to prepare these containers are from 0.940 to 0.960 g/cc. Lids for these containers have a preferred melt index of from 50 to 200 g/l0 minutes, especially from 70 to 170 g/l0 minutes. The preferred density for the “lid copolymers” is from 0.920 to 0.940 g/cc as this comparatively low density improves the flexibility of the lids. Larger containers (such as pails having a nominal volume of greater than 10 liters) have a preferred melt index of from 5 to 15, especially from 7 to 12 and a density of from 0.940 to 0.960 g/cc. Similarly, crates (i.e. large containers with walls which are an open lattice or mesh) have a preferred melt index of from 5 to 15, especially 7 to 12 and a density of from 0.940 to 0.960 g/cc.

As previously noted, a distinctive feature of this invention is that a dual reactor polymerization process (i.e. a polymerization process which uses at least two stirred tank polymerization reactors) is used to prepare a polyethylene resin having a narrow molecular weight distribution.

As will be appreciated by those skilled in the art, the use of a single site catalyst (such as a so-called metallocene catalyst) in a single polymerization reactor is now regarded as a convenient method to prepare polymers having a very narrow molecular weight distribution.

However, it is also possible to prepare a polyethylene resin having a narrow molecular weight distribution using a so-called Ziegler Natta catalyst in a very well mixed solution polymerization reactor, as disclosed in the aforementioned CA 2,201,224 and as illustrated herein in the examples.

Preferred polyethylene resins for use according to the present invention are further characterized by having a uniform comonomer distribution—i.e. a regular distribution of the comonomer branches within the resin. Comonomer distributions may be analytically determined by a number of techniques which are well known to those skilled in the art, including Temperature Rising Elution Fractionation, or “TREF”. Polyethylene copolymers with a poor comonomer distribution have a distinct homopolymer fraction. This may be expressed with a so-called copolymer/homopolymer or “COHO” weight ratio. Polyethylene copolymers having a poor comonomer distribution may have a COHO weight ratio of only 2/1 (i.e. the copolymer has 1 part by weight of homopolymer per 2 parts by weight copolymer—or, alternatively stated 33 weight % homopolymer). In contrast, the preferred resins for use in this invention have a COHO ratio of at least (4/1).

The use of two polymerization reactors to produce a product having a narrow molecular weight distribution requires that the products produced in each reactor have similar molecular weights. This may be achieved, for example, by using similar polymerization conditions (in particular, catalyst concentration, monomer concentration and reaction temperature) in two reactors. However, the use of the same reaction temperature for two polymerization reactors arranged in series requires either that heat is added to the first reactor or removed from the second reactor (due to the exothermic nature of the polymerization reactor). This may be done by using cold feed streams to the second reactor or by using a refrigeration system to remove the enthalpy of reaction. Alternatively, and as will be appreciated by those skilled in the art, molecular weight can be controlled by the use of a chain transfer agent (such as hydrogen) or by changing catalyst concentration (with lower catalyst concentrations typically causing higher molecular weights).

Further details of the polymerization process and catalyst systems are set out below.

Part A Catalysts

A.1 Single Site Catalysts

The catalysts used in this invention may be either “single site catalysts” or Ziegler Natta catalysts. As used herein, the term “single site catalysts” refers to ethylene polymerization catalysts which, when used under steady state condition (i.e. uniform polymerization conditions—particularly reactor temperature) may be used in a single polymerization reactor to prepare polyethylene having a polydispersity of less than 2.5. Many polymerization catalysts having one or two cyclopentadienyl-type ligands are single site catalysts. An exemplary (i.e. illustrative, but non-limiting) list includes:

a) monocylcopentadienyl complexes of group 4 or 5 transition metals such as those disclosed in U.S. Pat. No. 5,064,802 (Stevens et al, to Dow Chemical) and U.S. Pat. No. 5,026,798 (Canich, to Exxon);

b) metallocenes (i.e. organometallic complexes having two cyclopentadienyl ligands); and

c) phosphinimine catalysts (as disclosed in copending and commonly assigned patent applications, particularly Stephan et al and Brown et al—see Canadian Patent Applications 2,206,944 and 2,243,783).

Catalysts having a single cyclopentadienyl-type ligand and a single phosphinimine ligand are the preferred single site catalysts for use in this invention, as described below and illustrated in the Examples.

A.2 Description of Cocatalysts for Single Site Catalysts

The single site catalyst components described in Part 1 above are used in combination with at least one cocatalyst (or “activator”) to form an active catalyst system for olefin polymerization as described in more detail in Sections 2.1 and 2.2 below.

A.2.1 Alumoxanes

The alumoxane may be of the formula:

(R⁴)₂AIO(R⁴AIO)ₘAl(R⁴)₂

wherein each R⁴ is independently selected from the group consisting of C₁₋₂₀ hydrocarbyl radicals and m is from 0 to 50, preferably R⁴ is a C₁₋₄ alkyl radical and m is from 5 to 30. Methylalumoxane (or “MAO”) in which each R is methyl is the preferred alumoxane.

Alumoxanes are well known as cocatalysts, particularly for metallocene-type catalysts. Alumoxanes are also readily available articles of commerce.

The use of an alumoxane cocatalyst generally requires a molar ratio of aluminum to the transition metal in the catalyst from 20:1 to 1000:1. Preferred ratios are from 50:1 to 250:1.

A.2.2 “Ionic Activators” as Cocatalysts

So-called “ionic activators” are also well known for metallocene catalysts. See, for example, U.S. Pat. No. 5,198,401 (Hlatky and Turner) and U.S. Pat. No. 5,132,380 (Stevens and Neithamer).

Whilst not wishing to be bound by any theory, it is thought by those skilled in the art that “ionic activators” initially cause the abstraction of one or more of the activatable ligands in a manner which ionizes the catalyst into a cation, then provides a bulky, labile, non-coordinating anion which stabilizes the catalyst in a cationic form. The bulky, non-coordinating anion permits olefin polymerization to proceed at the cationic catalyst center (presumably because the non-coordinating anion is sufficiently labile to be displaced by monomer which coordinate to the cationic catalyst center). Preferred ionic activators are boron-containing ionic activators described in (i)-(iii) below:

(i) compounds of the formula [R⁵]⁺[B(R⁷)₄] wherein B is a boron atom, R⁵ is a aromatic hydrocarbyl (e.g. triphenyl methyl cation) and each R⁷ is independently selected from the group consisting of phenyl radicals which are unsubstituted or substituted with from 3 to 5 substituents selected from the group consisting of a fluorine atom, a C₁₋₄ alkyl or alkoxy radical which is unsubstituted or substituted by a fluorine atom; and a silyl radical of the formula —Si—(R⁹)₃; wherein each R⁹ is independently selected from the group consisting of a hydrogen atom and a C₁₋₄ alkyl radical; and

(ii) compounds of the formula [(R⁸)ₜZH]⁺[B(R⁷)₄] wherein B is a boron atom, H is a hydrogen atom, Z is a nitrogen atom or phosphorus atom, t is 2 or 3 and R⁸ is selected from the group consisting of C₁₋₈ alkyl radicals, a phenyl radical which is unsubstituted or substituted by up to three C₁₋₄ alkyl radicals, or one R⁸ taken together with the nitrogen atom may form an anilinium radical and R⁷ is as defined above; and

(iii) compounds of the formula B(R⁷)₃ wherein R⁷ is as defined above (Note: the compound B(R⁷)₃ is not, itself ionic. However whilst not wishing to be bound by theory, it is believed that the compound B(R⁷)₃ is sufficiently acidic to abstract a ligand (“L”) from the catalyst precursor, thereby forming an “ionic activator” of the formula [B(R⁷)₃(L)]⁻).

In the above compounds, preferably R⁷ is a pentafluorophenyl radical, R⁵ is a triphenylmethyl cation, Z is a nitrogen atom and R⁸ is a C₁₋₄ alkyl radical or R⁸ taken together with the nitrogen atom forms an anilinium radical which is substituted by two C₁₋₄ alkyl radicals.

The “ionic activator” may abstract one or more activatable ligands so as to ionize the catalyst center into a cation but not to covalently bond with the catalyst and to provide sufficient distance between the catalyst and the ionizing activator to permit a polymerizable olefin to enter the resulting active site.

Examples of ionic activators include:

triethylammonium tetra(phenyl)boron,

tripropylammonium tetra(phenyl)boron,

tri(n-butyl)ammonium tetra(phenyl)boron,

trimethylammonium tetra(p-tolyl)boron,

trimethylammonium tetra(o-tolyl)boron,

tributylammonium tetra(pentafluorophenyl)boron,

tripropylammonium tetra(o,p-dimethylphenyl)boron,

tributylammonium tetra(m,m-dimethylphenyl)boron,

tributylammonium tetra(p-trifluoromethylphenyl)boron,

tributylammonium tetra(pentafluorophenyl)boron,

tri(n-butyl)ammonium tetra(o-tolyl)boron,

N,N-dimethylanilinium tetra(phenyl)boron,

N,N-diethylanilinium tetra(phenyl)boron,

N,N-diethylanilinium tetra(phenyl)n-butylboron,

N,N-2,4,6-pentamethylanilinium tetra(phenyl)boron,

di-(isopropyl)ammonium tetra(pentafluorophenyl)boron,

dicyclohexylammonium tetra(phenyl)boron,

triphenylphosphonium tetra(phenyl)boron,

tri(methylphenyl)phosphonium tetra(phenyl)boron,

tri(dimethylphenyl)phosphonium tetra(phenyl)boron,

tropillium tetrakispentafluorophenyl borate,

triphenylmethylium tetrakispentafluorophenyl borate,

benzene (diazonium) tetrakispentafluorophenyl borate,

tropillium phenyltrispentafluorophenyl borate,

triphenylmethylium phenyltrispentafluorophenyl borate,

benzene (diazonium) phenyltrispentafluorophenyl borate,

tropillium tetrakis (2,3,5,6-tetrafluorophenyl) borate,

triphenylmethylium tetrakis (2,3,5,6-tetrafluorophenyl) borate,

benzene (diazonium) tetrakis (3,4,5-trifluorophenyl) borate,

tropillium tetrakis (3,4,5-trifluorophenyl) borate,

benzene (diazonium) tetrakis (3,4,5-trifluorophenyl) borate,

tropillium tetrakis (1,2,2-trifluoroethenyl) borate,

triphenylmethylium tetrakis (1,2,2-trifluoroethenyl) borate,

benzene (diazonium) tetrakis (1,2,2-trifluroethenyl) borate,

tropillium tetrakis (2,3,4,5-tetrafluorophenyl) borate,

triphenylmethylium tetrakis (2,3,4,5-tetrafluorophenyl) borate, and

benzene (diazonium) tetrakis (2,3,4,5-tetrafluorophenyl) borate.

Readily commercially available ionic activators include:

N, N-dimethylaniliniumtetrakispentafluorophenyl borate,

triphenylmethylium tetrakispentafluorophenyl borate, and

trispentafluorophenyl borane.

A.3. Description of Ziegler Natta Catalyst

The term “Ziegler Natta” catalyst is well known to those skilled in the art and is used herein to convey its conventional meaning. A Ziegler Natta catalyst may be used in this invention. Ziegler Natta catalysts comprise at least one transition metal compound of a transition metal selected from groups 3, 4 or 5 of the Periodic Table (using IUPAC nomenclature) and an organoaluminum component which is defined by the formula:

AI(X′)ₐ(OR)_{b}(R)_{c}

wherein: X′ is a halide (preferably chlorine); OR is an alkoxy or aryloxy group; R is a hydrocarbyl (preferably an alkyl having from 1 to 10 carbon atoms); and a, b or c are each 0, 1, 2 or 3 with the provisos text a+b+c=3 and b+c≧1.

It is highly preferred that the transition metal compounds contain at least one of titanium or vanadium. Exemplary titanium compounds include titanium halides (especially titanium chlorides, of which TiCl₄ is preferred); titanium alkyls; titanium alkoxides (which may be prepared by reacting a titanium alkyl with an alcohol) and “mixed ligand” compounds (i.e. compounds which contain more than one of the above described halide alkyl and alkoxide ligands). Exemplary vanadium compounds may also contain halide, alkyl or alkoxide ligands. In addition, vanadium oxy trichloride (“VOCl₃”) is known as a Ziegler Natta catalyst component and is suitable for use in the present invention.

It is especially preferred that the Ziegler Natta catalyst contain both of a titanium and a vanadium compound. The Ti/V mole ratios may be from 10/90 to 90/10, with mole ratios between 50/50 and 20/80 being particularly preferred.

The above defined organoaluminum compound is an essential component of the Ziegler Natta catalyst. The mole ratio of aluminum to transition metal [for example, aluminum/(titanium+vanadium)] is preferably from 1/1 to 100/1, especially from 1.2/1 to 15/1.

As will be appreciated by those skilled in the art of ethylene polymerization, conventional Ziegler Natta catalysts may also incorporate additional components such as an electron donor—for example an amine, or a magnesium compound—for example a magnesium alkyl such as butyl ethyl magnesium and a halide source (which is typically a chloride such as tertiary butyl chloride).

Such components, if employed, may be added to the other catalyst components prior to introduction to the reactor or may be directly added to the reactor.

The Ziegler Natta catalyst may also be “tempered” (i.e. heat treated) prior to being introduced to the reactor (again, using techniques which are well known to those skilled in the art and published in the literature). Preferred Ziegler Natta catalysts are described in more detail in U.S. Pat. Nos. 5,519,098 and 5,589,555 and in the Examples.

Part B Description of Dual Reactor Solution Polymerization Process

Solution processes for the copolymerization of ethylene and an alpha olefin having from 3 to 12 carbon atoms are well known in the art. These processes are conducted in the presence of an inert hydrocarbon solvent typically a C₅₋₁₂ hydrocarbon which may be unsubstituted or substituted by a C₁₋₄ alkyl group, such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.).

The solution polymerization process of this invention must use at least two polymerization reactors. The polymer solution resulting from the first reactor is transferred to the second polymerization (i.e. the reactors must be arranged “in series” so that polymerization in the second reactor occurs in the presence of the polymer solution from the first reactor).

The polymerization temperature may be from about 130° C. to about 300° C. However, it is preferred that the polymerization temperature in the first reactor is from about 130° C. to 160° C. and the hot reactor is preferably operated at a higher temperature as a result of the enthalpy of polymerization in the second reactor. Both reactors are preferably “stirred reactors” (i.e. the reactors are well mixed with a good agitation system). Preferred pressures are from about 500 psi to 8,000 psi. The most preferred reaction process is a “medium pressure process”, meaning that the pressure in each reactor is preferably less than about 6,000 psi (about 42,000 kiloPascals or kPa), most preferably from about 1,500 psi to 3,000 psi (about 14,000-22,000 kPa).

Suitable monomers for copolymerization with ethylene include C₃₋₁₂ alpha olefins which are unsubstituted or substituted by up to two C₁₋₆ alkyl radicals. Illustrative non-limiting examples of such alpha-olefins are one or more of propylene, 1-butene, 1-pentene, 1-hexene, 1-octene and 1-decene.

The polyethylene polymers which may be prepared in accordance with the present invention are ethylene copolymers which typically comprise not less than 60, preferably not less than 75 weight % of ethylene and the balance of one or more C₄₋₁₀ alpha olefins, preferably selected from the group consisting of 1-butene, 1-hexene and 1-octene.

The polyethylene also has a melt index (“I₂” as determined by ASTM standard D1238, condition 190/2.16) of from 5 to 200, preferably from 50 to 170 “grams per 10 minutes”. (The units may also be referred to as dg/min.) The monomers are dissolved/dispersed in the solvent either prior to being fed to the first reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the first reactor. Additional monomers and solvent may be added to the second reactor, and it may be heated or cooled.

Generally, the catalyst components may be premixed in the solvent for the reaction or fed as separate streams to each reactor. In some instances premixing it may be desirable to provide a reaction time for the catalyst components prior to entering the reaction. Such an “in line mixing” technique is described in a number of patents in the name of DuPont Canada Inc. (e.g. U.S. Pat. No. 5,589,555 issued Dec. 31, 1996).

The residence time in each reactor will depend on the design and the capacity of the reactor. In general, the reactions are operated under conditions which provide a thorough mixing of the reactants. It is preferred that from 20 to 60 weight % of the final polymer is polymerized in the first reactor, with the balance being polymerized in the second reactor. As previously noted, the polymerization reactors are arranged in series (i.e. with the solution from the first reactor being transferred to the second reactor). Thus, in a highly preferred embodiment, the first polymerization reactor has a smaller volume than the second polymerization reactor. On leaving the reactor system the solvent is removed and the resulting polymer is finished in a conventional manner.

It is also highly preferred that the polymerization reactors are equipped with highly efficient agitation systems, such as the agitator which is disclosed in CA 2,201,224. Whilst not wishing to be bound by theory, it is believed that the highly efficient agitator provides a comparatively homogenous polymerization mixture which in turn, improves the composition distribution of the resulting polyethylene—particularly when a non-homogeneous polymerization catalyst (such as a Ziegler Natta catalyst) is used.

Further details of the invention are illustrated in the following, non-limiting, examples. The examples are divided into three parts.

Test Procedures Used In The Examples Are Briefly Described Below

1. “Instrumented Impact Testing” was completed using a commercially available instrument (sold under the tradename “INSTRON-DYNATUP”) according to ASTM D3763.

2. Melt Index: I₂ and I₆ were determined according to ASTM D1238.

3. Stress exponent is calculated by

$$\frac{log ( {I}_{6} / {I}_{2} )}{log ( 3 )} .$$

4. Number average molecular weight (Mn), weight average molecular weight (Mw), z-average molecular weight (Mz) and polydispersity (calculated by Mw/Mn) were determined by Gel Permeation Chromatography (“GPC”).

5. Flexural Secant Modulus and Flexural Tangent Modulus were -determined according to ASTM D790.

6. Elongation, Yield and Tensile Secant Modulus measurements were determined according to ASTM D636.

7. Hexane Extractables were determined according to ASTM D5227.

8. Densities were determined using the displacement method according to ASTM D792.

9. COHO ratios were determined by Temperature Rising Elution Fractionation (“TREF”).

### EXAMPLES

Part 1

(Comparative) Polymerization of Injection Molding Resins for Containers in a Single Reactor Process

This example illustrates the continuous flow, solution copolymerization of ethylene at a medium pressure using a two reactor system using a Ziegler Natta catalyst. Both reactors are continuously stirred tank reactors (“CSTR'S”). The first reactor operates at a relatively low temperature. This reactor is equipped with a highly efficient agitator of the type disclosed in CA 2,201,224. The contents from the first reactor flow into the second reactor.

The second reactor had a volume of 24 liters. Monomers, solvent and catalyst were fed into the reactor as indicated in Table 1. The solvent used in these experiments was methyl pentane. Flow rates to the second reactor are also shown in Table 1.

The catalyst employed in all experiments was one known to those skilled in the art as a “Ziegler Natta” catalyst and consisted of titanium tetrachloride (TiCl₄), dibutyl magnesium (DBM) and tertiary butyl chloride (TBC), with an aluminum activator consisting of triethyl aluminum (TEAL) and diethyl aluminum ethoxide (DEAO). The molar ratio of the components was:

TBC:DBM (2-2.2:1);

DEAO:TiCl₄ (1.5-2:1); and

TEAL:TiCl₄ (1-1.3:1).

All catalyst components were mixed in methyl pentane. The mixing order was DBM, TEAL (5:1 molar ratio) and TBC; followed by TiCl₄; followed by DEAO. The catalyst was pumped into the reactor together with the methyl pentane solvent. The catalyst flow rate had an aim point as shown in the table and was adjusted to maintain total ethylene conversions above 90%.

TABLE 1

| | Reactor 1 | Reactor 2 |
|---|---|---|
| Ethylene (kg/h) | — | 89 |
| Octene (kg/h) | — | 6.6 |
| Hydrogen (g/h) | — | 12.1 |
| Solvent (kg/h) | — | 490 |
| Reactor Temp. (° C.) | — | 189 |
| TiCl₄ to Reactor (ppm) | — | 5.07 |

Table 2 provides data which describe the physical properties of the thermoplastic ethylene-octene resin produced in Part 1.

TABLE 2
Injection Molding Resin for Containers
Material Name S1

| Properties | |
|---|---|
| Rheology/Flow Properties | |
| Melt Index I₂ (g/10 min) | 8.7 |
| Melt Index I₆ (g/10 min) | 35.5 |
| Stress Exponent | 1.28 |
| Viscosity at 10000 s⁻¹ and 250° C. (Pa-s) | 41.26 |
| Flexural Testing | |
| Flex Secant Mod. 1% (MPa) | 1200 |
| Flex Secant Mod. 1% Dev. (MPa) | 63 |
| Flex Secant Mod. 2% (MPa) | 1055 |
| Flex Secant Mod. 2% Dev. (MPa) | 44 |
| Flex Tangent Mod. (MPa) | 983 |
| Flex Tangent Mod. Dev. (MPa) | 135 |
| Flexural Strength (MPa) | 36.7 |
| Flexural Strength Dev. (MPa) | 0.5 |
| Tensile Testing | |
| Elong. at Yield % | 8 |
| Elong. at Yield Dev. (%) | 0.4 |
| Yield Strength (MPa) | 26.9 |
| Yield Strength Dev. (MPa) | 0.5 |
| Ultimate Elong. (%) | 2150 |
| Ultimate Elong. Dev. (%) | 130 |
| Ultimate Strength (MPa) | 26.1 |
| Ultimate Strength Dev. (MPa) | 1 |
| GPC | |
| No. Ave. Mol. Wt. (MN) × 10⁻³ | 17.4 |
| Wt. Ave. Mol. Wt. (MW) × 10⁻³ | 59.1 |
| Z Ave. Mol. Wt. (MZ) × 10⁻³ | 181.3 |
| Polydispersity Index | 3.3 |
| Other | |
| Hexane Extractables (%) | 0.14 |
| Density (g/cm³) | 0.953 |

Part 2

Polymerization of “Container” Resins

This example illustrates the use of both single and dual reactor configurations with the Ziegler Natta catalyst. The same polymerization reactors described in Part 1 were used for these experiments. The first reactor polymerization conditions (including flow rates of monomers, solvent and catalyst) are shown in Table 3. The solvent used in these experiments was methyl pentane. The contents of the first reactor were discharged through an exit port into a second reactor having a volume of 24 liters. Flow rates to the second reactor are also shown in Table 3.

A comparison of properties between the comparative single reactor and inventive dual reactor resins is given in Table 4.

TABLE 3

| | S2 | D1 |
|---|---|---|
| Reactor 1 | | |
| Ethylene (kg/h) | — | 15 |
| Octene (kg/h) | — | 3.1 |
| Hydrogen (g/h) | — | 3 |
| Solvent (kg/h) | — | 133 |
| Reactor Temp. (° C.) | — | 165 |
| TiCl₄ to Reactor (ppm) | — | 3.71 |
| Reactor 2 | | |
| Ethylene (kg/h) | 88 | 85 |
| Octene (kg/h) | 16 | 11 |
| Hydrogen (g/h) | 31 | 43 |
| Solvent (kg/h) | 476 | 386 |
| Reactor Temp. (° C.) | 195 | 196 |
| TiCl₄ to Reactor (ppm) | 6.67 | 3.95 |

TABLE 4
Injection Molding Resin For Containers

Material Name

| Properties | S2 | D1 |
|---|---|---|
| Rheology/Flow Properties | | |
| Melt Index I₂ (g/10 min) | 90.3 | 65.1 |
| Melt Index I₆ (g/10 min) | 337.5 | 251.4 |
| Stress Exponent | 1.2 | 1.23 |
| Viscosity at 100000 s⁻¹ and 250° C. (Pa-s) | 3.41 | 3.73 |
| Flexural Testing | | |
| Flex Secant Mod. 1% (MPa) | 1346 | 1371 |
| Flex Secant Mod. 1% Dev. (MPa) | 58 | 41 |
| Flex Secant Mod. 2% (MPa) | 1191 | 1204 |
| Flex Secant Mod. 2% Dev. (MPa) | 70 | 31 |
| Flex Tangent Mod. (MPa) | 1312 | 1333 |
| Flex Tangent Mod. Dev. (MPa) | 312 | 306 |
| Flexural Strength (MPa) | 39 | 39 |
| Flexural Strength Dev. MPa | 1 | 1 |
| Tensile Testing | | |
| Elong. at Yield (%) | 5 | 6 |
| Elong. at Yield Dev. (%) | 0.3 | 1 |
| Yield Strength (MPa) | 26.9 | 28.2 |
| Yield Strength Dev. (MPa) | 0.2 | 0.3 |
| Ultimate Elong. (%) | 11 | 14 |
| Ultimate Elong. Dev. (%) | 4 | 6 |
| Ultimate Strength (MPa) | 26.3 | 26.5 |
| Ultimate Strength Dev. (MPa) | 0.6 | 2.1 |
| GPC | | |
| No. Ave. Mol. Wt. (MN) × 10⁻³ | 12.00 | 9.90 |
| Wt. Ave. Mol. Wt. (MW) × 10⁻³ | 32.60 | 38.60 |
| Z Ave. Mol. Wt. (MZ) × 10⁻³ | 107.70 | 211.80 |
| Polydispersity Index | 2.72 | 3.87 |
| Other | | |
| Hexane Extractables (%) | 0.34 | 0.34 |
| Density (g/cm³) | 0.952 | 0.953 |

Part 3

Preparation of an Injection Molded Container

This example illustrates the preparation of containers using an injection molding apparatus. A commercially available injection molding machine was used. The mold was an ASTM test mold, which makes tensile test specimens with an overall length of 1.30 inches (in), an overall width of 0.75 in, and a thickness of 0.12 in; tensile test specimens with an overall length of 1.375 in, an overall width of 0.375 in, and a thickness of 0.12 in; tensile test specimens with an overall length of 2.5 in, an overall width of 0.375 in, and a thickness of 0.12 in; flexural modulus bars with a length of 5 in, a width of 0.50 in, and a thickness of either 0.12 in or 0.75 in; and an impact disk with a diameter of 2 in and a thickness of 0.12 in.

Conventional barrel temperatures for this apparatus typically range from 150 to 300° C. Conventional temperatures were used, as shown in Table 5. Other molding conditions are also shown in Table 5.

Table 6 provides data which show that containers made with the resin from Example 1 had excellent physical properties, with better stiffness, tensile elongation, and impact behavior than containers made with a commercially available injection molding grade “2815” (sold by NOVA Chemicals Corporation under the trademark SCLAIR 2815). SCLAIR 2815 is prepared with a single stirred polymerization reactor and a Ti/V catalyst. The increased stiffness of S1 allows the molder to further reduce part thickness and weight, resulting in savings of raw material costs. Processing advantages will also be seen by the customer due to the lower viscosity of S1 compared to the comparative sample.

For the resins of Part 2, a machine sold under the tradename Husky LX 225 P60/60 E70 was used. The mold used for the samples in Part 2 was a 4-cavity mold making containers with a nominal outside diameter of 4.68 inches and a thickness of 0.025 inches.

Conventional barrel temperatures for this apparatus typically range from 150 to 300° C. Conventional temperatures were used, as shown in Table 7. Other molding conditions are shown in Table 8.

In a conventional injection molding cycle, the molten resin is injected into a closed mold which is water cooled. It is desirable to maximize the productivity of these expensive machines, while also reducing energy requirements. In order to achieve this, the resin must have excellent Theological properties (i.e. so that the resin flows sufficiently to completely fill the mold).

Table 8 provides data which shows that the resin S2 from Example 2 requires lower pressure to mold a part. As a result, the barrel temperatures may be lowered in order to reduce energy consumption while maintaining cycle time. The resulting containers had excellent physical properties, with better stiffness, tensile elongation, and impact behavior, indicating that the improvement in processability is not achieved at the expense of physical integrity. Table 8 also includes comparative data from a commercially available resin “2318” (which is an injection molding resin produced by NOVA Chemicals in a single stirred reactor using a Ti/V catalyst and sold under the tradename “SCLAIR 2318”). As well, the increased stiffness compared to the commercially available grade will allow the molder to further reduce part thickness and weight, resulting in savings of raw material costs.

TABLE 5

| | Barrel T | Barrel T | | | | | Injection | Injection | | Clamp | Clamp |
|---|---|---|---|---|---|---|---|---|---|---|---|
| Barrel T | (° C.) | (° C.) | Barrel T | Injection | Injection | | Pressure- | Pressure- | Back | Pressure- | Pressure- |
| (° C.) Feed | Trans. | Metering | (° C.) | Time- | Time- | Cooling | High | Low | Pressure | High | Low |
| Section | Section | Section | Nozzle | High(s) | Low(s) | Time(s) | (psi) | (psi) | (psi) | (psi) | (psi) |
| 193.3 | 226.7 | 226.7 | 226.7 | 6 | 4 | 20 | 700 | 550 | 150 | 1750 | 1000 |

TABLE 6

| | | | | | | Instron- | Instron- | Instron- | Instron- |
|---|---|---|---|---|---|---|---|---|---|
| | Tensile | Tensile | Tensile | Tensile | Flexural | Dynatup | Dynatup | Dynatup | Dynatup |
| | Elongation | Yield | Elongation | Break | Tangent | Maximum | Total Energy | Maximum | Total |
| | at Yield | Strength | at Break | Strength | Modulus | Load at | at 23° C. (ft- | Load at | Energy at |
| Sample | (%) | (MPa) | (%) | (MPa) | (MPa) | 23° C. (lb_{f}) | lb_{f}) | −20° C. (lb_{f}) | −20° C. (ft-lb_{f}) |
| S1 | 8.8 | 21.8 | 667 | 19.4 | 1032 | 480 | 18.8 | 590.5 | 20.9 |
| 6706 | 10 | 21.5 | 561 | 15.5 | 858 | 477 | 18.5 | 577 | 20.8 |

TABLE 7

| Barrel T | Barrel T | Barrel T | Barrel T | Barrel T | | | Shooting | Shooting | Shooting | | |
|---|---|---|---|---|---|---|---|---|---|---|---|
| (° C.) | (° C.) | (° C.) | (° C.) | (° C.) | B/H T | BHE T | Pot 1 T | Pot 2 T | Pot Head T | Dis T | Nozzle |
| Zone 1 | Zone 2 | Zone 3 | Zone 4 | Zone 5 | (° C.) | (° C.) | (° C.) | (° C.) | (° C.) | (° C.) | T (° C.) |
| 200 | 210 | 220 | 230 | 250 | 250 | 250 | 250 | 250 | 250 | 250 | 250 |

TABLE 8

| | | | | Extruder | | Maximum | | | | |
|---|---|---|---|---|---|---|---|---|---|---|
| | | Screw | Screw Back | Drive | | Injection | Hold | Hold | Hold | Effective |
| | Cycle | Speed | Pressure | Pressure | Injection | Pressure | Pressure 1 | Pressure 2 | Pressure 3 | Cooling |
| Sample | Time(s) | (rpm) | (psi) | (psi) | Time(s) | (psi) | (psi) | (psi) | (psi) | Time(s) |
| S2 | 5.91 | 158 | 271.7 | 1119.1 | 0.39 | 2192.1 | 1053.4 | 646.2 | 390.6 | 2.57 |
| D1 | 5.86 | 158 | 276.1 | 1163.5 | 0.36 | 2235.3 | 1160.8 | 704.9 | 439.3 | 2.57 |
| 2815 | 5.82 | 158 | 273.9 | 1157.9 | 0.39 | 2206.5 | 1041.3 | 647.3 | 389.5 | 2.56 |

| | | | | | | Instron- | Instron- | Instron- | Instron- |
|---|---|---|---|---|---|---|---|---|---|
| | Tensile | Tensile | Tensile | Tensile | Tensile | Dynatup | Dynatup | Dynatup | Dynatup |
| | Elongation | Yield | Elongation | Break | Secant | Maximum | Total Energy | Maximum | Total |
| | at Yield | Strength | at Break | Strength | Modulus at | Load at | at 23° C. (ft- | Load at | Energy at |
| Sample | (%) | (MPa) | (%) | (MPa) | 1% (MPa) | 23° C. (lb_{f}) | lb_{f}) | −20° C. (lb_{f}) | −20° C. (ft-lb_{f}) |
| S2 | 6.9 | 19.2 | 691 | 15.6 | 1808 | 194.2 | 6.5 | 226.6 | 3.8 |
| D1 | 7.6 | 20.5 | 700 | 20 | 2074 | 194.1 | 6.3 | 208.8 | 3.9 |
| 2318 | 9.8 | 19.5 | 530 | 15.1 | 1764 | 211.1 | 3.9 | 250.2 | 3.8 |

Part 4

This example illustrates the preparation of injection molding resins used for the preparation of container lids.

The polymerization reactors used in Part 1 were also used in the experiments of this example.

A “Ziegler Natta” catalyst consisting of titanium tetrachloride (TiCl₄), dibutyl magnesium (DBM) and tertiary butyl chloride (TBC), with an aluminum activator consisting of triethyl aluminum (TEAL) and diethyl aluminum ethoxide (DEAO) was first used. The molar ratio of the components was:

TBC:DBM (2-2.2:1);

DEAO:TiCl₄ (1.5-2:1); and

TEAL: TiCl₄ (1-1.3:1).

All catalyst components were mixed in methyl pentane. The mixing order was DBM, TEAL (5:1 molar ratio) and TBC; followed by TiCl₄; followed by DEAO. The catalyst was pumped into the reactor together with the methyl pentane solvent. The catalyst flow rate had an aim point as shown in the table and was adjusted to maintain total ethylene conversions above 90%. Polymerization conditions are shown in Table 9.

TABLE 9

| | Reactor 1 | Reactor 2 |
|---|---|---|
| Ethylene (kg/h) | — | 80 |
| Octene (kg/h) | — | 45 |
| Hydrogen (g/h) | — | 36 |
| Solvent (kg/h) | — | 417 |
| Reactor Temp. (° C.) | — | 195 |
| TiCl₄ to Reactor (ppm) | — | 4.8 |

Table 10 provides data which describe the physical properties of the thermoplastic ethylene-octene resin produced according to the polymerization conditions shown in Table 8.

TABLE 10
Injection Molding Resin For Lids
Material Name S3

| Properties | |
|---|---|
| Rheology/Flow Properties | |
| Melt Index I₂ (g/10 min) | 150 |
| Melt Index I₆ (g/10 min) | 548.4 |
| Stress Exponent | 1.18 |
| Viscosity at 100000 s⁻¹ and 200° C. (Pa-s) | 3.95 |
| Flexural Testing | |
| Flex Secant Mod. 1% (MPa) | 546 |
| Flex Secant Mod. 1% Dev. (MPa) | 14 |
| Flex Secant Mod. 2% (MPa) | 493 |
| Flex Secant Mod. 2% Dev. (MPa) | 12 |
| Flex Tangent Mod. (MPa) | 543 |
| Flex Tangent Mod. Dev. (MPa) | 105 |
| Flexural Strength (MPa) | 19.9 |
| Flexural Strength Dev. (MPa) | 0.3 |
| Tensile Testing | |
| Elong. at Yield (%) | 6 |
| Elong. at Yield Dev. (%) | 1 |
| Yield Strength (MPa) | 15.9 |
| Yield Strength Dev. (MPa) | 0.6 |
| Ultimate Elong. (%) | 60 |
| Ultimate Elong. Dev. (%) | 7 |
| Ultimate Strength (MPa) | 8.2 |
| Ultimate Strength Dev. (MPa) | 1.2 |
| GPC | |
| No. Ave. Mol. Wt. (MN) × 10⁻³ | 11.8 |
| Wt. Ave. Mol. Wt. (MW) × 10⁻³ | 31.0 |
| Z Ave. Mol. Wt. (MZ) × 10⁻³ | 103.8 |
| Polydispersity Index | 2.64 |
| Other | |
| Hexane Extractables (%) | 1.45 |
| Density (g/cm³) | 0.933 |

Part 5

This example illustrates the preparation of “lid resins” using a single site phosphinimine catalyst.

The catalyst used in each experiment is a titanium complex having one cyclopentadienyl ligand; one tri(tertiary butyl) phosphinimine ligand; and two chloride ligands (“CpTNP(^{t}Bu)₃ Cl₂”). The cocatalyst used was a combination of a commercially available methylalumoxane (sold under the tradename MMAO-7 by Akzo Nobel) and trityl borate (or Ph₃CB(C₆F₃)₄, where Ph represents phenyl, purchased from Asahi Glass).

The same polymerization reactors described in Part 1 were used for these experiments. Table 11 provides a summary of polymerization conditions. Dual reactor operation utilized both reactors to make the polymer. The first reactor had a volume of 12 liters. Monomers, solvent and catalyst were fed into the reactor as indicated in Table 11. The solvent used in these experiments was methyl pentane. The contents of the first reactor were discharged through an exit port into a second reactor having a volume of 24 liters. Flow rates to the second reactor are also shown in Table 11.

The catalyst and trityl borate were co-fed through a common line (thus permitting some contact prior to the reaction) and the MMAO-7 was added directly to the reactor.

A comparison of properties between the single and dual reactor resins is given in Table 11.

TABLE 11

| Sample # | SP1 | DP1 |
|---|---|---|
| Melt Index I₂ (g/10 min) | 120.3 | 112.3 |
| Melt Index I₆ (g/10 min) | 285.7 | 329 |
| Stress Exponent | 1.10 | 1.22 |
| Viscosit at 100000 s⁻¹ and 200° C. (Pa-s) | 4.80 | 4.00 |
| Density (g/cm³) | 0.934 | 0.936 |
| No. Ave. Mol. Wt. (MN) × 10⁻³ | 7.7 | 6.0 |
| Wt. Ave. Mol. Wt. MW × 10⁻³ | 27.9 | 28.8 |
| Z Ave. Mol. Wt. (MZ) × 10⁻³ | 45.9 | 58.7 |
| Polydispersity Index | 3.63 | 4.80 |
| Reactor 1 | | |
| Ethylene (kg/hr) | — | 30 |
| 1-octene (kg/hr | — | 52 |
| Hydrogen (g/hr) | — | — |
| Temperature (° C.) | — | 170 |
| Total Flow (kg/hr) | — | 278 |
| Ti (micromol/l) | — | 1.2 |
| Al/Ti (mol/mol) | — | 40 |
| B/Ti (mol/mol) | — | 1.0 |
| Reactor 2 | | |
| Ethylene (kg/hr) | 100 | 70 |
| 1-octene (kg/hr) | 55 | 0 |
| Hydrogen (g/hr) | 30 | 20 |
| Temperature (° C.) | 200 | 195 |
| Total Flow (kg/hr) | 590 | 713 |
| Ti (micromol/l) | 1.5 | 2.0 |
| Al/Ti (mol/mol) | 100 | 40 |
| B/Ti (mol/mol) | 1.2 | 1.0 |

Part 6

Preparation of an Injection Molded Lid

This example illustrates the preparation of lids using an injection molding apparatus. A commercially available apparatus (sold under the tradename Husky LX 225 P60/60 E70) was used.

The mold was a 6-cavity mold making round lids with a nominal outside diameter of 4.68 inches and a thickness of 0.025 inches.

Conventional barrel temperatures for this apparatus typically range from 150 to 300° C. Conventional temperatures were used, as shown in Table 12. Other molding conditions are shown in Table 13.

In a conventional injection molding cycle, the molten resin is injected into a closed mold which is water cooled. It is desirable to maximize the productivity of these expensive machines, while also reducing energy requirements. In order to achieve this, the resin must have excellent rheological properties (i.e. so that the resin flows sufficiently to completely fill the mold).

Table 13 provides data which show that the resin S3 (described in Table 10) requires lower pressure to mold a part. As a result, the barrel temperatures may be lowered in order to reduce energy consumption while maintaining cycle time. The resulting lids had excellent physical properties, with better stiffness, tensile elongation, and impact behavior than a competitive grade, indicating that the improvement in processability is not achieved at the expense of physical integrity. As well, the increased stiffness will allow the molder to further reduce part thickness and weight, resulting in savings of raw material costs.

TABLE 12

| Barrel T | Barrel T | Barrel T | Barrel T | Barrel T | | | Shooting | Shooting | Shooting | | |
|---|---|---|---|---|---|---|---|---|---|---|---|
| (° C.) | (° C.) | (° C.) | (° C.) | (° C.) | B/HT | BHE T | Pot 1 T | Pot 2 T | Pot Head T | Dis T | Nozzle |
| Zone 1 | Zone 2 | Zone 3 | Zone 4 | Zone 5 | (° C.) | (° C.) | (° C.) | (° C.) | (° C.) | (° C.) | T (° C.) |
| 200 | 210 | 220 | 230 | 230 | 230 | 230 | 230 | 230 | 230 | 230 | 230 |

TABLE 13

| | | | | Extruder | | Maximum | | | | |
|---|---|---|---|---|---|---|---|---|---|---|
| | | Screw | Screw Back | Drive | | Injection | Hold | Hold | Hold | Effective |
| | Cycle | Speed | Pressure | Pressure | Injection | Pressure | Pressure 1 | Pressure 2 | Pressure 3 | Cooling |
| Sample | Time(s) | (rpm) | (psi) | (psi) | Time(s) | (psi) | (psi) | (psi) | (psi) | Time(s) |
| S3 | 4.73 | 198 | 277.2 | 870.1 | 0.37 | 873.1 | 957.2 | 401.7 | 224.6 | 1.31 |
| 2318 | 4.75 | 197 | 273.9 | 926.6 | 0.38 | 932.8 | 955 | 403.9 | 226.9 | 1.32 |

| | | | | | | Instron- | Instron- | Instron- | Instron- |
|---|---|---|---|---|---|---|---|---|---|
| | Tensile | Tensile | Tensile | Tensile | Tensile | Dynatup | Dynatup | Dynatup | Dynatup |
| | Elongation | Yield | Elongation | Break | Secant | Maximum | Total Energy | Maximum | Total |
| | at Yield | Strength | at Break | Strength | Modulus at | Load at | at 23° C. (ft- | Load at | Energy at |
| Sample | (%) | (MPa) | (%) | (MPa) | 1% (MPa) | 23° C. (lb_{f}) | lb_{f}) | −20° C. (lb_{f}) | −20° C. (ft-lb_{f}) |
| 53 | 13 | 10.7 | 431 | 9 | 953 | 177 | 5.7 | 230 | 7.3 |
| 2318 | 13 | 10.8 | 353 | 9.9 | 718 | 182 | 5.2 | 187 | 6.1 |

What is claimed is:

1. An injection molded part made from polyethylene copolymer characterized in that said polyethylene copolymer is polymerized in a polymerization process having at least two stirred polymerization reactors arranged in series and operating at different polymerization temperatures.

2. The part according to claim 1 wherein said polymerization process is a solution polymerization process which operates at a temperature of from 120° C. to 300° C.

3. The process according to claim 2 wherein said polyethylene copolymer is a copolymer of ethylene and at least one alpha olefin selected from butene, hexene and octene.

4. The process according to claim 3 wherein each of said at least two stirred polymerization reactors has independent feed streams for monomer and polymerization catalyst.

5. The process according to claim 4 wherein said polymerization catalyst comprises at least one group 4 metal component wherein said group 4 metal is selected from titanium, hafnium and zirconium; and at least one group 13 metal component wherein said group 13 metal is selected from aluminum and boron.

6. The process according to claim 5 wherein said group 4 metal is titanium.

7. The process according to claim 6 wherein each of said independent feed streams for said monomer is operated such that said monomer is added to each of said polymerization reactors at a temperature of at least 20° C. lower than the polymerization temperature of said polymerization reactors.

8. The process according to claim 7 wherein said injection molded part is a container having a volume of less than 4 liters and wherein said polyethylene is further characterized by having:
a) a density of from 0.940 to 0.960 grams per cubic centimeter; and
b) a melt index, I_{2,} as determined by ASTM standard D1238, condition 190° C./2.16 kg of from 20 to 100 grams per 10 minutes.

9. The process according to claim 7 wherein said injection molded part is a container lid and wherein said polyethylene is further characterized by having:
a) a density of from 0.920 to 0.940 grams per cubic centimeter; and
b) a melt index, I_{2,} as determined by ASTM standard D1238, condition 190° C./2.16 kg of from 50 to 100 grams per 10 minutes.

10. The process according to claim 7 wherein said injection molded part is a pail or crate having a volume of greater than 10 liters and wherein said polyethylene is further characterized by having:
a) a density of from 0.940 to 0.960 grams per cubic centimeter; and
b) a melt index, I_{2,} as determined by ASTM standard D1238, condition 190° C./2.16 kg of from 5 to 15 grams per 10 minutes.
